(19) United States
(12) Patent Application Publication
(10) Pub. No.: US 2018/0020385 A1
(43) Pub. Date: Jan. 18, 2018

(54) Optimized Timer Value for Controlling Access Network Selection and Traffic Steering in 3GPP/WLAN Radio Interworking1

(71) Applicant: Nokia Solutions and Networks Oy, Espoo (FI)

(72) Inventors: Daniela LASELVA, Klarup (DK); Frank FREDERIKSEN, Klarup (DK); Jeroen WIGARD, Klarup (DK)

(21) Appl. No.: 15/545,001

(22) PCT Filed: Jan. 28, 2015
(86) PCT No.: PCT/EP2015/051671

§ 371 Date: Jul. 20, 2017

(51) Int. Cl. H04W 36/14; H04W 36/22; H04W 48/18; H04W 88/06

(52) U.S. Cl. CPC H04W 36/14; H04W 48/18; H04W 36/22; H04W 88/06

(57) ABSTRACT

The present invention provides apparatuses, methods, computer programs, computer program products and computer-readable media regarding an optimized time-to-trigger for WLAN radio interworking. The present invention comprises defining, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, wherein the timer value to be applied for network selection differs from the timer value applied for traffic steering, and transmitting, by the network element, the timer value to the user equipment.

### FIELD OF THE INVENTION

The present invention relates to apparatuses, methods, systems, computer programs, computer program products and computer-readable media regarding an optimized time-to-trigger for WLAN radio interworking.

### BACKGROUND OF THE INVENTION

In particular, the present invention relates to radio enhancements for 3GPP/WLAN (3^{rd} Generation Partnership Project/Wireless Local Area Network) interworking that aims to support improved operator assisted connectivity over WLAN, as discussed in the Release 12 3GPP work item (RP-132101).

The solution for the 3GPP/WLAN radio interworking agreed by RAN2 relies on various thresholds, which are part of the RAN (Radio Access Network) assistance information. These thresholds are to be used by the UE when evaluating offloading/onloading conditions, i.e. RAN defined rules or ANDSF (Access Network Discovery and Selection Function) rules. Such rules allow the network to provide guidance related to where the UE (User Equipment) should be initiating a session (Network Selection (NS)) and whether an existing session should be routed to a different RAT (Radio Access Technology) (Traffic Steering (TS)).

When the RAN adopts/activates this Release 12 solution, named “RAN-assisted WLAN interworking” in 3GPP, it is possible for the eNB (evolved NodeB) (the cellular network in general) to “push” or “pull” traffic to or from the WLAN network, and in general allows to do some kind of load balancing between the considered radio technologies. The mentioned thresholds relate to the RAN and WLAN signal strength/quality and load level metrics. Any threshold can be signalled to both UEs in IDLE and CONNECTED mode by using broadcast messages (System Information Block, SIB) from the RAN. In addition, UEs in CONNECTED mode can receive any of the thresholds via dedicated signalling (RRC (Radio Resource Control) signalling) as well.

An excerpt from TS 36.304 (CR R2-144028) is provided below to illustrate the thresholds and the corresponding conditions/rules.

The upper layers in the UE shall be notified when and for which WLAN identifiers (out of the list in RAN parameters in subclause 5.6.3) the following conditions 1 and 2 for steering traffic from E-UTRAN to WLAN are satisfied for a time interval Tsteerincr_{WLAN}:
1. In the E-UTRAN serving cell:
   RSRPmeas<Thresh_{ServingOffloadWLAN, LowP}; or
   RSRQmeas<Thresh_{ServingOffloadWLAN, LowQ};
2. In the target WLAN:
   ChannelUtilizationWLAN<Thresh_{ChUtilWLAN, Low}; and
   BackhaulRateDlWLAN>Thresh_{BackhRateDLWLAN, High}; and
   BackhaulRateUlWLAN>Thresh_{BackhRateULWLAN, High}; and
   BeaconRSSI>Thresh_{BeaconRSSIWLAN, High};

The upper layers in the UE shall be notified when the following conditions 3 or 4 for steering traffic from WLAN to
3. In the source WLAN:
   ChannelUtilizationWLAN>Thresh_{ChUtilWLAN, High}; or
   BackhaulRateDlWLAN<Thresh_{BackhRateDLWLAN, Low}; or
   BackhaulRateUlWLAN<Thresh_{BackhRateULWLAN, Low}; or
   BeaconRSSI<Thresh_{BeaconRSSIWLAN, Low};
4. In the target E-UTRAN cell:
   RSRPmeas>Thresh_{ServingOffloadWLAN; HighP}; and
   RSRQmeas>Thresh_{ServingOffloadWLAN; HighQ};

In the above, RSRP is the Reference Signal Received Power and RSRQ is the Reference Signal Received Quality.

The above mentioned RAN assistance parameters for RAN-assisted WLAN interworking have the following meaning, as defined in TS 36.304 (CR R2-144028):

Thresh_{ServingOffloadWLAN, LowP} This specifies the RSRP threshold (in dBm) used by the UE for traffic steering to from E-UTRAN to WLAN.

Thresh_{ServingOffloadWLAN, HighP} This specifies the RSRP threshold (in dBm) used by the UE for traffic steering from WLAN to E-UTRAN.

Thresh_{ServingOffloadWLAN, LowQ}: This specifies the RSRQ threshold (in dB) used by the UE for traffic steering from E-UTRAN to WLAN.

Thresh_{ServingOffloadWLAN, HighQ} This specifies the RSRQ threshold (in dB) used by the UE for traffic steering from WLAN to E-UTRAN.

Thresh_{ChUtilWLAN, Low}: This specifies the WLAN channel utilization (Basic Service Set (BSS) load) threshold used by the UE for traffic steering from E-UTRAN to WLAN.

Thresh_{ChUtilWLAN, High}: This specifies the WLAN channel utilization (BSS load) threshold used by the UE for traffic steering from WLAN to E-UTRAN.

Thresh_{BackhRateDLWLAN, Low}: This specifies the backhaul available downlink bandwidth threshold used by the UE for traffic steering from WLAN to E-UTRAN.

Thresh_{BackhRateDLWLAN, High}: This specifies the backhaul available downlink bandwidth threshold used by the UE for traffic steering from E-UTRAN to WLAN.

Thresh_{BackhRateULWLAN, Low}: This specifies the backhaul available uplink bandwidth threshold used by the UE for traffic steering from WLAN to E-UTRAN.

Thresh_{BackhRateULWLAN, High}: This specifies the backhaul available uplink bandwidth threshold used by the UE for traffic steering from E-UTRAN to WLAN.

Thresh_{BeaconRSSIWLAN, Low}: This specifies the Beacon RSSI threshold used by the UE for traffic steering from WLAN to E-UTRAN.

Thresh_{BeaconRSSIWLAN, High}: This specifies the Beacon RSSI threshold used by the UE for traffic steering from E-UTRAN to WLAN.

Additionally to the above parameters and thresholds, Tsteering_{WLAN} is a defined network-configured parameter, i.e. timer value, which specifies the time interval during which the rules should be fulfilled before starting traffic steering between E-UTRAN and WLAN.

This parameter is intended to avoid undesired offloading/onloading decisions due to fluctuations in instanteneous load/radio conditions which may lead to ping pong situations between the two RATs. Each time traffic steering is triggered, i.e. when the UE evaluation of onloading/offloading rules is successful, a number of actions needs to be taken. For instance, the traffic routing, i.e. the path that the traffic will take, needs to be updated, and the UE may need to re-connect to the respective radio access technology (RAT). Such operations take time and may introduce a service interruption.

It can be observed that the same conditions for offloading and onloading, listed above, have to be evaluated both during NS and for TS. Also, those conditions during both NS and TS have to be satisfied for the same time interval, Tsteering_{WLAN}, before starting traffic steering between E-UTRAN and WLAN. The RSRP related thresholds are intended to be tuned based on the experienced 3GPP cell load condition. This means that, for instance, RAN may attempt to onload traffic when experiencing low load situations, by increasing the RSRP threshold High, irrespective of the current WLAN conditions. After the RSRP thresholds update, onload may occur for both existing connections and new connections. If such onloading decision may be desired for new sessions, it may however, cause undesired service interruption for the existing sessions even when the serving WLAN is providing good enough service.

The time-to-trigger (TTT) is specified and typically adopted for optimizing 3GPP mobility, as mentioned for example in the technical specification TS 36.331. A speed-dependent scaling is applied as well according to the UE mobility state. The above mentioned Tsteering_{WLAN} WLAN parameter follows the typical TTT concept.

### SUMMARY OF THE INVENTION

It is therefore an object of the present invention to overcome the above mentioned problems and to provide apparatuses, methods, systems, computer programs, computer program products and computer-readable media regarding an optimized time-to-trigger for WLAN radio interworking.

According to an aspect of the present invention there is provided a method comprising:
defining, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, wherein
the timer value to be applied for network selection differs from the timer value applied for traffic steering; and
transmitting, by the network element, the timer value to the user equipment.

According to another aspect of the present invention there is provided a method comprising:
defining, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
determining, by the network element, a throughput of the user equipment in a current communication session;
adjusting, by the network element, the timer value based on the current throughput of the user equipment; and
transmitting, by the network element, the timer value to the user equipment.

According to another aspect of the present invention there is provided a method comprising:
receiving, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, and
applying, by the user equipment, different timer values for network selection and for traffic steering.

According to another aspect of the present invention there is provided a method comprising:
receiving, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
receiving, by the user equipment from the network element, a scaling factor based on a throughput of the user equipment in a current communication session; and
adjusting the timer value based on the scaling factor.

According to another aspect of the present invention there is provided a method comprising:
setting, at a user equipment, a predetermined timer value indicating a time period during which rules for traffic management by a user equipment have to be fulfilled before the user equipment is allowed to start the traffic management, the traffic management including network selection of initiating a communication session in a communication network according to one of a first or second radio access technology and traffic steering of switching a communication session from the first communication network according to the first radio access technology to a second communication network according to a second radio access technology,
counting a timer, and
if the timer exceeds the predetermined timer value while the rules are fulfilled,
resetting the timer.

According to another aspect of the present invention there is provided an apparatus for use in a network element, comprising:
at least one processor,
and
at least one memory for storing instructions to be executed by the processor, wherein
the at least one memory and the instructions are configured to, with the at least one processor, cause the apparatus at least to perform
defining, by the network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, wherein
the timer value to be applied for network selection differs from the timer value applied for traffic steering; and
transmitting, by the network element, the timer value to the user equipment.

According to another aspect of the present invention there is provided an apparatus for use in a network element, comprising:
at least one processor,
and
at least one memory for storing instructions to be executed by the processor, wherein
the at least one memory and the instructions are configured to, with the at least one processor, cause the apparatus at least to perform
defining, by the network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
determining, by the network element, a throughput of the user equipment in a current communication session;
adjusting, by the network element, the timer value based on the current throughput of the user equipment; and
transmitting, by the network element, the timer value to the user equipment.

According to another aspect of the present invention there is provided an apparatus for use in a user equipment, comprising:
at least one processor,
and
at least one memory for storing instructions to be executed by the processor, wherein
the at least one memory and the instructions are configured to, with the at least one processor, cause the apparatus at least to perform
receiving, at the user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, and
applying, by the user equipment, different timer values for network selection and for traffic steering.

According to another aspect of the present invention there is provided an apparatus for use in a user equipment, comprising:
at least one processor,
and
at least one memory for storing instructions to be executed by the processor, wherein
the at least one memory and the instructions are configured to, with the at least one processor, cause the apparatus at least to perform
receiving, at the user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
receiving, by the user equipment from the network element, a scaling factor based on a throughput of the user equipment in a current communication session; and
adjusting the timer value based on the scaling factor.

According to another aspect of the present invention there is provided an apparatus for use in a user equipment, comprising:
at least one processor,
and
at least one memory for storing instructions to be executed by the processor, wherein
the at least one memory and the instructions are configured to, with the at least one processor, cause the apparatus at least to perform
setting, at the user equipment, a predetermined timer value indicating a time period during which rules for traffic management by a user equipment have to be fulfilled before the user equipment is allowed to start the traffic management, the traffic management including network selection of initiating a communication session in a communication network according to one of a first or second radio access technology and traffic steering of switching a communication session from the first communication network according to the first radio access technology to a second communication network according to a second radio access technology,
counting a timer, and
if the timer exceeds the predetermined timer value while the rules are fulfilled,
resetting the timer.

According to another aspect of the present invention there is provided an apparatus, comprising:
means for defining, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, wherein
the timer value to be applied for network selection differs from the timer value applied for traffic steering; and
means for transmitting, by the network element, the timer value to the user equipment.

According to another aspect of the present invention there is provided an apparatus, comprising:
means for defining, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
means for determining, by the network element, a throughput of the user equipment in a current communication session;
means for adjusting, by the network element, the timer value based on the current throughput of the user equipment; and
means for transmitting, by the network element, the timer value to the user equipment.

According to another aspect of the present invention there is provided an apparatus, comprising:
means for receiving, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, and
means for applying, by the user equipment, different timer values for network selection and for traffic steering.

According to another aspect of the present invention there is provided an apparatus, comprising:
means for receiving, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
means for receiving, by the user equipment from the network element, a scaling factor based on a throughput of the user equipment in a current communication session; and
means for adjusting the timer value based on the scaling factor.

According to another aspect of the present invention there is provided an apparatus, comprising:
means for setting, at a user equipment, a predetermined timer value indicating a time period during which rules for traffic management by a user equipment have to be fulfilled before the user equipment is allowed to start the traffic management, the traffic management including network selection of initiating a communication session in a communication network according to one of a first or second radio access technology and traffic steering of switching a communication session from the first communication network according to the first radio access technology to a second communication network according to a second radio access technology,
means for counting a timer, and
if the timer exceeds the predetermined timer value while the rules are fulfilled,
means for resetting the timer.

According to another aspect of the present invention there is provided a computer program product comprising code means adapted to produce steps of any of the methods as described above when loaded into the memory of a computer.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

### BRIEF DESCRIPTION OF THE DRAWINGS

These and other objects, features, details and advantages will become more fully apparent from the following detailed description of aspects/embodiments of the present invention which is to be taken in conjunction with the appended drawings, in which:

FIG. 1 is a flowchart illustrating an example of a method according to some example versions of the present invention;

FIG. 2 is a flowchart illustrating another example of method according to some example versions of the present invention;

FIG. 3 is a flowchart illustrating another example of a method according to some example versions of the present invention;

FIG. 4 is a flowchart illustrating another example of a method according to some example versions of the present invention;

FIG. 5 is a flowchart illustrating another example of a method according to some example versions of the present invention;

FIG. 6 is a block diagram illustrating an example of an apparatus according to some example versions of the present invention.

### DETAILED DESCRIPTION

In the following, some example versions of the disclosure and embodiments of the present invention are described with reference to the drawings. For illustrating the present invention, the examples and embodiments will be described in connection with a cellular communication network based on a 3GPP based communication system, for example an LTE/LTE-A based system, and a wireless communication network such as, for example, WLAN. However, it is to be noted that the present invention is not limited to an application using such types of communication systems or communication networks, but is also applicable in other types of communication systems or communication networks and the like.

The following examples versions and embodiments are to be understood only as illustrative examples. Although the specification may refer to “an”, “one”, or “some” example version(s) or embodiment(s) in several locations, this does not necessarily mean that each such reference is to the same example version(s) or embodiment(s), or that the feature only applies to a single example version or embodiment. Single features of different embodiments may also be combined to provide other embodiments. Furthermore, words “comprising” and “including” should be understood as not limiting the described embodiments to consist of only those features that have been mentioned and such example versions and embodiments may also contain also features, structures, units, modules etc. that have not been specifically mentioned.

The basic system architecture of a communication network where examples of embodiments of the invention are applicable may comprise a commonly known architecture of one or more communication systems comprising a wired or wireless access network subsystem and a core network. Such an architecture may comprise one or more communication network control elements, access network elements, radio access network controller elements, access service network gateways or base transceiver stations, such as a base station (BS), an access point (AP) or an eNB, which control a respective coverage area or cell and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities, operation and maintenance elements, and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signalling links may be employed for a communication to or from a communication element or terminal device like a UE and a communication network control element like a radio network controller, besides those described in detail herein below.

The communication network is also able to communicate with other networks, such as a public switched telephone network or the Internet. The communication network may also be able to support the usage of cloud services. It should be appreciated that BSs and/or eNBs or their functionalities may be implemented by using any node, host, server or access node etc. entity suitable for such a usage.

Furthermore, the described network elements and communication devices, such as terminal devices or user devices like UEs, communication network control elements of a cell, like a BS or an eNB, access network elements like APs and the like, as well as corresponding functions as described herein may be implemented by software, e.g. by a computer program product for a computer, and/or by hardware. In any case, for executing their respective functions, correspondingly used devices, nodes or network elements may comprise several means, modules, units, components, etc. (not shown) which are required for control, processing and/or communication/signalling functionality. Such means, modules, units and components may comprise, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means comprising e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

According to some example versions of the present invention, there is proposed a method to mitigate the above described undesired issues when a UE is running existing sessions.

According to some example versions of the present invention, in the context of 3GPP WLAN Radio Interworking, there is proposed a set of optimization possibilities for the Tsteering_{WLAN} parameter in order to optimize the onloading/offloading decisions resulting in improved end user performance.

According to some example versions of the present invention, there are proposed the following aspects.

### Aspect#1:

According to a first aspect of the present invention, the parameter Tsteering_{WLAN} is split into two values such that the timer value can be set individually for network selection (NS) and traffic steering (TS).

That is, the RAN can set and send individual values of the Tsteering_{WLAN} parameter for NS and TS, i.e. Tsteering_{WLAN,NS} and Tsteering_{WLAN,TS}, respectively. The UE will then apply the corresponding parameter Tsteering_{WLAN} in case of existing/new connections, accordingly, that is, in case of existing connections, the parameter Tsteering_{WLAN,TS} is applied and in case of new connections, the parameter Tsteering_{WLAN,NS} is applied.

In this way, the RAN could set a longer value in case of TS as compared to NS to minimize the risk that the UE having an existing connection has to perform traffic routing as it may result in service interruption.

Alternatively, the RAN can send only one Tsteering_{WLAN} parameter e.g. Tsteering_{WLAN,NS} and additionally a value ΔT (timer offset) which the UE should apply to compute the Tsteering_{WLAN,TS}, i.e. Tsteering_{WLAN, TS}=Tsteering_{WLAN,NS}+ΔT.

Of course, the calculation could also be done vice versa, i.e. Tsteering_{WLAN,NS}=Tsteering_{WLAN, TS}−ΔT, for example.

### Aspect#2:

According to a second aspect of the present invention, after a connection setup to either RAT, the UE resets the parameter Tsteering_{WLAN} which was previously running at the connection setup. This will ensure a minimum time of the UE in active mode on the RAT to which the UE has connected, increasing the likelihood that the UE is able to finish its data reception or transmission before a potential break caused by the transition is made.

That is, the second aspect of the present invention relates to what the UE should do after a network selection to either RAT has taken place based on the offloading/onloading rules. In case the UE previously was running the timer to check whether the offloading/onloading rules were fulfilled during the time interval set by parameter Tsteering_{WLAN,NS}/Tsteering_{WLAN}, it should now reset that timer. That is, it should reset the current elapsed time during which the NS rules were fulfilled either to 0 (in case of count up) or to the maximum timer value of the parameter Tsteering_{WLAN,TS}/Tsteering_{WLAN}, (in case of countdown). After the reset, the UE should apply the appropriate time interval for TS, i.e. Tsteerin_{WLAN,TS} in case the parameter is split, or Tsteering_{WLAN} in case there exists only one parameter.

Further, it is noted that the reset should happen also for the reverse transition, when UE moves from evaluating rules for traffic steering to evaluating rules for network selection, i.e. once the UE moves back to IDLE.

### Aspect#3:

According to a third aspect of the present invention, the RAN performs network-based scaling of the parameter Tsteering_{WLAN} based on the experienced UE throughput in order to make the onloading/offloading decision faster in case the UE throughput is degrading.

Assuming an interface between the RAN and WLAN AP/Controller, this approach can be applied also when the UE is having existing traffic over WLAN since the RAN could acquire dedicated information related to dedicated UE such as UE throughput. Basically, one can say that the higher data rate the UE experiences, the longer it would like to stay on the current radio access technology, in the form of an increased Tsteering_{WLAN} value.

In summary, the main advantage provided by some example versions of the present invention as described above is to optimize the onloading/offloading decisions resulting in improved end user performance. This is achieved by e.g. avoiding undesired decisions and/or speeding up the evaluations when required.

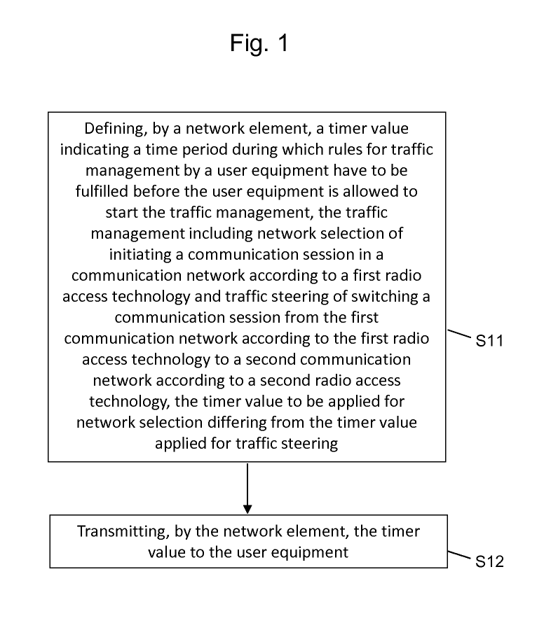

In the following, a more general description of example versions of the present invention is made with respect to FIGS. 1 to 6.

FIG. 1 is a flowchart illustrating an example of a method according to example versions of the present invention.

According to example versions of the present invention, the method may be implemented in or may be part of a network element of a RAN or the like. The method comprises defining in a step S11, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, wherein the timer value to be applied for network selection differs from the timer value applied for traffic steering, and transmitting, by the network element, the timer value to the user equipment in a step S12.

According to example versions of the present invention, the method further comprises defining, by the network element, a timer offset for the timer value, and transmitting, by the network element, the timer offset to the user equipment, wherein, for the network selection, the timer value defined by the network element is applied, and for the traffic steering, the timer value to which the timer offset has been added is applied.

According to example versions of the present invention, the timer value includes a first timer value applied for network selection, and a second timer value applied for traffic steering, and the second timer value is higher than the first timer value.

According to example versions of the present invention, the method further comprises determining, by the network element, a throughput of the user equipment in a current communication session, and adjusting the timer value based on the current throughput of the user equipment.

According to example versions of the present invention, the higher the throughput of the user equipment is, the higher the timer value is.

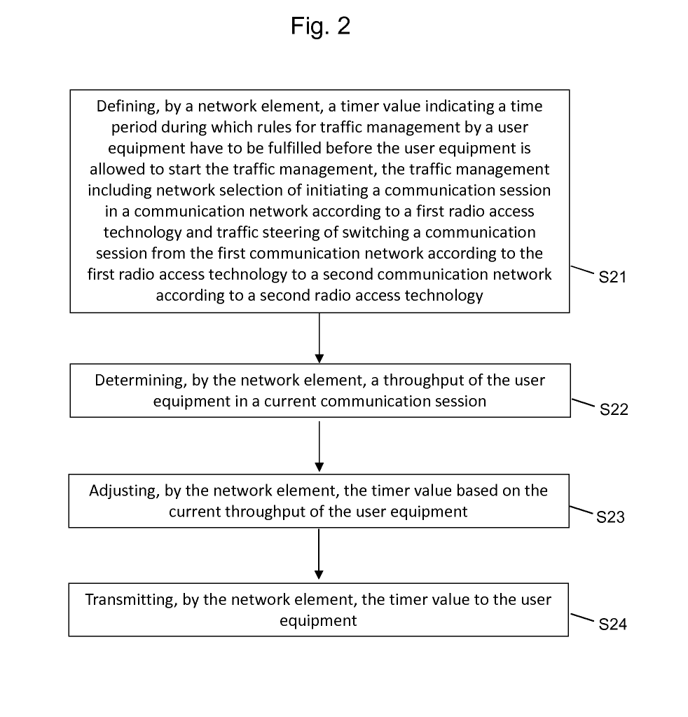

FIG. 2 is a flowchart illustrating another example of a method according to example versions of the present invention.

According to example versions of the present invention, the method may be implemented in or may be part of a network element of a RAN or the like. The method comprises defining in a step S21, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology; determining, by the network element, a throughput of the user equipment in a current communication session in a step S22, adjusting, by the network element, the timer value based on the current throughput of the user equipment in a step S23, and transmitting, by the network element, the timer value to the user equipment in a step S24.

According to example versions of the present invention, the higher the throughput of the user equipment is, the higher the timer value is.

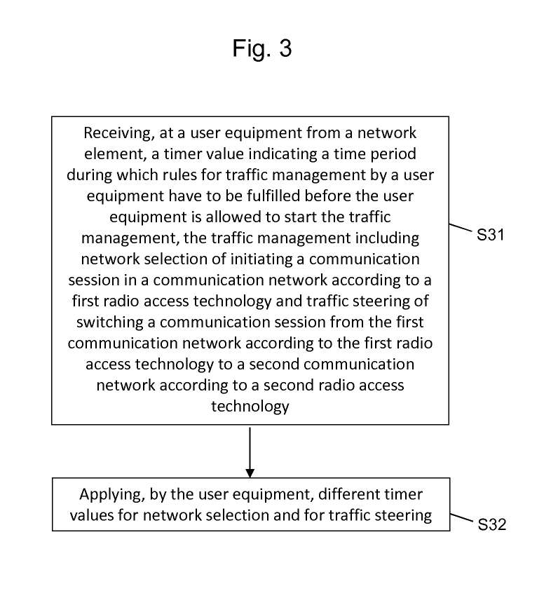

FIG. 3 is a flowchart illustrating another example of a method according to example versions of the present invention.

According to example versions of the present invention, the method may be implemented in or may be part of a user equipment or the like. The method comprises receiving in a step S31, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, and applying, by the user equipment, different timer values for network selection and for traffic steering in a step S32.

According to example versions of the present invention, the method further comprises receiving, by the user equipment, a timer offset for the timer value, and applying, by the user equipment, for the network selection the timer value received from the network element, and applying, by the user equipment, for the traffic steering the timer value to which the timer offset has been added.

According to example versions of the present invention, the timer value includes a first timer value and a second timer value, the second timer value being higher than the first timer value, and the method further comprises applying, by the user equipment, the first timer value for network selection, and applying, by the user equipment, the second timer value for traffic steering.

According to example versions of the present invention, the method further comprises receiving, by the user equipment from the network element, a scaling factor based on a throughput of the user equipment in a current communication session; and adjusting the timer value based on the scaling factor.

According to example versions of the present invention, the higher the throughput of the user equipment is, the higher the timer value is.

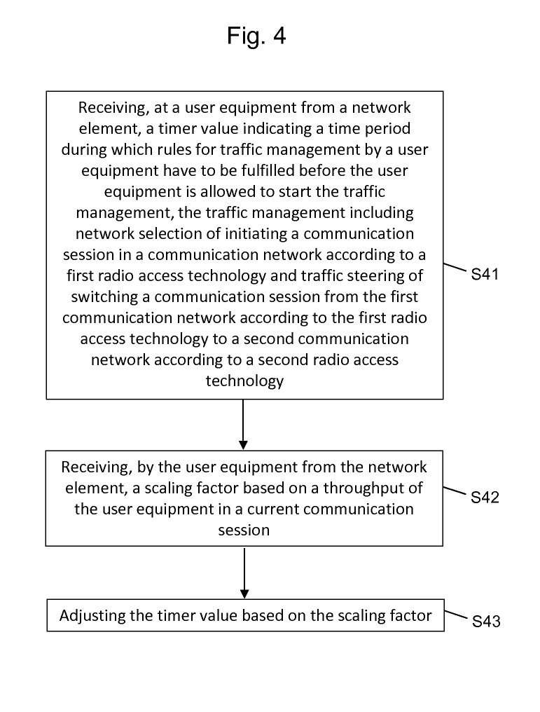

FIG. 4 is a flowchart illustrating another example of a method according to example versions of the present invention.

According to example versions of the present invention, the method may be implemented in or may be part of a user equipment or the like. The method comprises receiving in a step S41, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology; receiving in a step S42, by the user equipment from the network element, a scaling factor based on a throughput of the user equipment in a current communication session; and adjusting the timer value based on the scaling factor in a step S43.

According to example versions of the present invention, the higher the throughput of the user equipment is, the higher the timer value is.

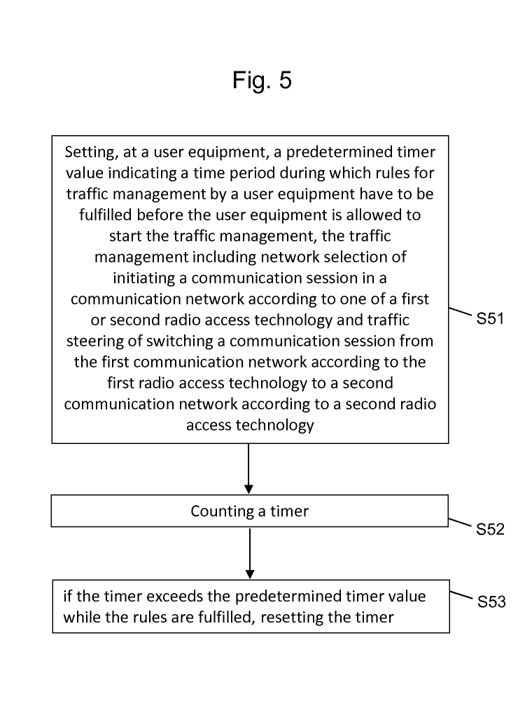

FIG. 5 is a flowchart illustrating another example of a method according to example versions of the present invention.

According to example versions of the present invention, the method may be implemented in or may be part of a user equipment or the like. The method comprises setting in a step S51, at a user equipment, a predetermined timer value indicating a time period during which rules for traffic management by a user equipment have to be fulfilled before the user equipment is allowed to start the traffic management, the traffic management including network selection of initiating a communication session in a communication network according to one of a first or second radio access technology and traffic steering of switching a communication session from the first communication network according to the first radio access technology to a second communication network according to a second radio access technology, counting a timer in a step S52, and if the timer exceeds the predetermined timer value while the rules are fulfilled, resetting the timer in a step S53.

According to example versions of the present invention, the timer value includes a first timer value applied for network selection, and a second timer value applied for traffic steering, the second timer value is higher than the first timer value, and the method further comprises applying the second timer value after the timer exceeds the first timer value while the rules are fulfilled, and applying the first timer value after the timer exceeds the second timer value while the rules are fulfilled.

According to example versions of the present invention, the first communication network is one of a cellular communication network and a wireless local communication network, and the second communication network is the other one of the cellular communication network and the wireless local communication network.

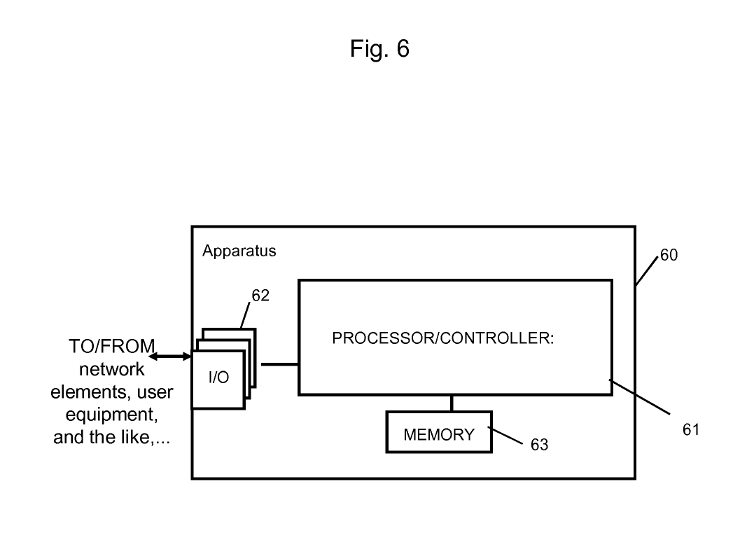

FIG. 6 is a block diagram showing an example of an apparatus according to some example versions of the present invention.

In FIG. 6, a block circuit diagram illustrating a configuration of an apparatus 60 is shown, which is configured to implement the above described aspects of the invention. It is to be noted that the apparatus 60 shown in FIG. 6 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 60 may comprise a processing function or processor 61, such as a CPU or the like, which executes instructions given by programs or the like. The processor 61 may comprise one or more processing portions dedicated to specific processing as described below, or the processing may be run in a single processor. Portions for executing such specific processing may be also provided as discrete elements or within one or further processors or processing portions, such as in one physical processor like a CPU or in several physical entities, for example. Reference sign 62 denotes transceiver or input/output (I/O) units (interfaces) connected to the processor 61. The I/O units 62 may be used for communicating with one or more other network elements, entities, terminals or the like. The I/O units 62 may be a combined unit comprising communication equipment towards several network elements, or may comprise a distributed structure with a plurality of different interfaces for different network elements. The apparatus 60 further comprises at least one memory 63 usable, for example, for storing data and programs to be executed by the processor 61 and/or as a working storage of the processor 61.

The processor 61 is configured to execute processing related to the above described aspects. In particular, the apparatus 60 may be implemented in or may be part of a network element of a RAN or the like, and may be configured to perform a method as described in connection with FIG. 1. Thus, the processor 61 is configured to perform defining, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, wherein the timer value to be applied for network selection differs from the timer value applied for traffic steering; and transmitting, by the network element, the timer value to the user equipment.

According to some example versions of the present invention, the apparatus 60 may be implemented in or may be part of a network element of a RAN or the like, and may be configured to perform a method as described in connection with FIG. 2. Thus, the processor 61 is configured to perform defining, by a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology; determining, by the network element, a throughput of the user equipment in a current communication session; adjusting, by the network element, the timer value based on the current throughput of the user equipment; and transmitting, by the network element, the timer value to the user equipment.

According to some example versions of the present invention, the apparatus 60 may be implemented in or may be part of a user equipment or the like, and may be configured to perform a method as described in connection with FIG. 3. Thus, the processor 61 is configured to perform receiving, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology, and applying, by the user equipment, different timer values for network selection and for traffic steering.

According to some example versions of the present invention, the apparatus 60 may be implemented in or may be part of a user equipment or the like, and may be configured to perform a method as described in connection with FIG. 4. Thus, the processor 61 is configured to perform receiving, at a user equipment from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology; receiving, by the user equipment from the network element, a scaling factor based on a throughput of the user equipment in a current communication session; and adjusting the timer value based on the scaling factor.

According to some example versions of the present invention, the apparatus 60 may be implemented in or may be part of a user equipment or the like, and may be configured to perform a method as described in connection with FIG. 5. Thus, the processor 61 is configured to perform setting, at a user equipment, a predetermined timer value indicating a time period during which rules for traffic management by a user equipment have to be fulfilled before the user equipment is allowed to start the traffic management, the traffic management including network selection of initiating a communication session in a communication network according to one of a first or second radio access technology and traffic steering of switching a communication session from the first communication network according to the first radio access technology to a second communication network according to a second radio access technology, counting a timer, and if the timer exceeds the predetermined timer value while the rules are fulfilled, resetting the timer.

For further details regarding the functions of the apparatus 60, reference is made to the description of the methods according to some example versions of the present invention as described in connection with FIGS. 1 to 5.

Thus, it is noted that the apparatus for use in a network element, and the apparatus for use in a user equipment according to the above described aspects, generally have the same structural components, wherein these components are configured to execute the respective functions of the network element and the user equipment, respectively, as set out above.

In the foregoing exemplary description of the apparatus, only the units/means that are relevant for understanding the principles of the invention have been described using functional blocks. The apparatus may comprise further units/means that are necessary for its respective operation, respectively. However, a description of these units/means is omitted in this specification. The arrangement of the functional blocks of the apparatus is not construed to limit the invention, and the functions may be performed by one block or further split into sub-blocks.

When in the foregoing description it is stated that the apparatus (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

For the purpose of the present invention as described herein above, it should be noted that
method steps likely to be implemented as software code portions and being run using a processor at an apparatus (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the aspects/embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the aspects/embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is noted that the aspects/embodiments and general and specific examples described above are provided for illustrative purposes only and are in no way intended that the present invention is restricted thereto. Rather, it is the intention that all variations and modifications which fall within the scope of the appended claims are covered.

1-38. (canceled)

39. A method, comprising:
receiving, at a user equipment from a network element, a timer value indicating a time period during which rules for traffic management by a user equipment have to be fulfilled before the user equipment is allowed to start the traffic management, the traffic management including network selection of initiating a communication session in a first communication network according to a first radio access technology and traffic steering of switching a communication session from the first communication network according to the first radio access technology to a second communication network according to a second radio access technology;
receiving, by the user equipment from the network element, a scaling factor based on a throughput of the user equipment in a current communication session; and
adjusting the timer value based on the scaling factor.

40. The method according to claim 39, wherein
the higher the throughput of the user equipment is, the higher the adjusted timer value is.

41. The method according to claim 39, wherein the first communication network is one of a cellular communication network and a wireless local communication network, and
the second communication network is the other one of the cellular communication network and the wireless local communication network.

42. The method according to claim 39, further comprising:
applying the adjusted time timer to a network selection; and
applying a second timer value to a traffic steering, wherein the second timer value configured to exceed the adjusted timer value.

43. A network element comprising:
at least one processor, and
at least one memory for storing instructions to be executed by the processor, wherein
the at least one memory and the instructions are configured to, with the at least one processor, cause the network element at least to:
define a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
determine a throughput of the user equipment in a current communication session;
and at least one:
adjust the timer value based on the throughput of the user equipment; and transmit the timer value to the user equipment; and
determine a scaling factor for the timer value based on the throughput of the user equipment; and transmit the scaling factor to the user equipment.

44. The network element according to claim 43, wherein
the higher the throughput of the user equipment is, the higher the adjusted timer value is set.

45. The network element according to claim 43, wherein the first communication network is one of a cellular communication network and a wireless local communication network, and
the second communication network is the other one of the cellular communication network and the wireless local communication network.

46. The network element according to claim 45, wherein the network element is a network element of the cellular communication network.

47. A user equipment, comprising:
at least one processor, and
at least one memory for storing instructions to be executed by the processor, wherein
the at least one memory and the instructions are configured to, with the at least one processor, cause the user equipment at least to perform
receiving from a network element, a timer value indicating a time period during which rules for traffic management by a user equipment have to be fulfilled before the user equipment is allowed to start the traffic management, the traffic management including network selection of initiating a communication session in a communication network according to a first radio access technology and traffic steering of switching a communication session from the first communication network according to the first radio access technology to a second communication network according to a second radio access technology;
receiving from the network element, a scaling factor based on a throughput of the user equipment in a current communication session; and
adjusting the timer value based on the scaling factor.

48. The user equipment according to claim 47, wherein
the higher the throughput of the user equipment is, the higher the adjusted timer value is.

49. The user equipment according to claim 47, wherein the first communication network is one of a cellular communication network and a wireless local communication network, and
the second communication network is the other one of the cellular communication network and the wireless local communication network.

50. The user equipment according to claim 47, the at least one memory and the instructions are further configured to, with the at least one processor, cause the user equipment at least to perform:
apply the adjusted time timer to a network selection; and
apply a second timer value to a traffic steering, wherein the second timer value configured to exceed the adjusted timer value.
